(19) United States
(12) Patent Application Publication
(10) Pub. No.: US 2006/0015726 A1
(43) Pub. Date: Jan. 19, 2006

(54) Apparatus for partial authentication of messages

(76) Inventor: Jonathan D. Callas, San Jose, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/895,259

(22) Filed: Jul. 19, 2004

(51) Int. Cl. H04L 9/00

(52) U.S. Cl. 713/170

(57) ABSTRACT

A computer readable medium includes executable instructions to insert partial authentication content into a message. The modified message is then delivered through an electronic network to a recipient. Upon receipt, the partial authentication content is processed without processing the entire message. This results in an authentication response indicative of the authenticity of the message. In some instances the message is partially authenticated and therefore delivered. In other instances, the message is not partially authenticated and various processing options are invoked, such as quarantining the message, modifying the message with a warning, modifying the message to remove content, and/or sending a message to a spoofed machine advising the spoofed machine of a spoofed message. The authentication operations of the invention may also be used in connection with the implicit content of the message.

### BRIEF DESCRIPTION OF THE INVENTION

This invention relates generally to the processing of messages in an electronic network. More particularly, this invention relates to efficient techniques for the partial authentication of messages exchanged in an electronic network.

### BACKGROUND OF THE INVENTION

Digital signatures are widely used to provide authentication of messages delivered in an electronic network. Although digital signatures provide the requisite authenticity for a message, they have a number of concomitant drawbacks.

One problem with digital signatures is that if even one bit of the signed content is changed, signature verification fails. This becomes problematic because messages are often processed in accordance with various rules that might make non-substantive changes to the content of the message. Content must be processed to ensure that it is interpreted upon verification the way it was when it was signed. Thus, non-substantive changes imposed by the sending machine must be identified on the receiving machine. This type of coordination between unrelated machines is difficult to obtain. Non-substantive message transformations are referred to as canonicalizing messages, which means conforming message transformations to a set of rules or patterns.

The problems associated with message canocilazation can be understood with reference to specific examples. Structured content, such as XML, contains actual content plus irrelevant content, such as white space and formatting. Tags may need to be canonicalized as case insensitive, while the body data may be treated as case sensitive. The XML Digital Signature standard has canonicalization rules, but there are still format problems with signatures on XML structures. For example, is it the text representation of a number or the numeric representation that is supposed to be signed? If it is the numeric representation, then the numbers 0100 and 00100 will have the same signature, but this will not be true if it is the text representation.

HTML has similar canonicalization problems, but with no canonicalization rules. While there are at least three standards that could be applicable to signed email—OpenPGP, S/MIME, and XML Digital Signatures, none of them are well supported for complex messages. The sort of complex messages that businesses send to their customers and are the most attractive to spoof have the least general interoperability with signing, and the least support for MIME display complexities and MIME-security.

Character sets also cause canonicalization issues. There is not a single representation of all characters. There are a number of eight-bit character sets that handle West European characters, East European characters, Cyrillic, Greek, Turkish, Hebrew, and so on. These problems are supposed to be solved by the Unicode character set. However, the Unicode character set does not completely solve the problem. Unicode characters are two to four bytes long, but are typically encoded into a smaller space with UTF encoding. The most common of these is UTF-8, which lets the 127 most commonly used ASCII characters to be coded into a single byte. It is not unusual to mandate that all signatures be done over a single character set and encoding, but there is resistance to this approach.

ASCII text also has canonicalization issues. There are at least three types of line endings in text. There is no standard definition of how wide a tab is, nor is there any agreement on how to handle backspaces, bare carriage returns (either of which might cause text to be overwritten or overstruck), or trailing whitespace at the end of a line.

Closely related to canonicalization issues is the fact that data may be lost. The lose might happen mechanically, through translation, or because there is no equivalent way to express a given notation. Two Russian speakers might have translation issues if one is using the ISO Russian character set and the other is using the Windows character set.

It is not always possible to sign some messages because of the processing that the messages go through. For example, an email message that goes through a forwarded address will not have the same headers that it would have if it were sent directly. Firewalls often remove headers that are not understood or add headers. A processing system may add or remove content at the end of a message. The processing system may also intentionally change content to defend a user from hostile or confusing content.

The meaning of a signed statemetn may not always be apparent. For example, the meaning of the signed statement “I ♥ my dog” may or may not be apparent. Similarly, a signature of “I [symbol] my dog” may also be confusing. The foregoing statements were created with a markup language that then generated symbols. This can lead to both translation and canonicalization issues.

There may be other coding issues. Email may be super-encoded into quoted-printable form, some characters in URLs may have percent-sign encoding, text may be automatically wrapped, flowed, or have undergone automatic character translation. Any or all of these alterations could be present in the same message. Spammers use these techniques as chaff against spam filters as well as throwing in HTML comments and nonsensical tags.

Another problem with signature based authentication is that content may be dynamic. For example, does signing a URL mean that the URL itself is signed, or is the content that it points to actually signed? Similarly, what does it mean to sign a Java applet, an activeX control, or a flash movie? Does the signature assert authenticity of the source? Does the signature imply a contractual agreement to the content?

There may also be confusion surrounding the significance of a signature. Is a signature a binding declaration that the signer will abide by all of the content of the message? Is a signature merely an indication that the message has not been altered since it left the signer's infrastructure? Because of these questions, it may be undesirable to sign something in view of how the verifier might interpret the signature.

There are also computation costs associated with digital signatures. Despite the fact that CPUs are faster and getting faster, public key operations are still relatively expensive in CPU cycles. It is possible that a system generates so many messages and verifications that signatures cannot be processed in a practical system.

Yet another potential problem with digital signatures relates to aesthetics. A sender may not want to sign a message because the clear signed or MIME-encoded message may not display as the sender intended.

In view of these numerous issues surrounding digital signatures, it would be highly desirable to provide a form of authentication, without the limitations associated with existing authentication techniques.

### SUMMARY OF THE INVENTION

In one embodiment of the invention, a computer readable medium includes executable instructions to insert partial authentication content into a message. The modified message is then delivered through an electronic network to a recipient. Upon receipt, the partial authentication content is processed without processing the entire message. This results in an authentication response indicative of the authenticity of the message. In some instances the message is partially authenticated and therefore delivered. In other instances, the message is not partially authenticated and various processing options are invoked, such as quarantining the message, modifying the message with a warning, modifying the message to remove content, and/or sending a message to a spoofed machine advising the spoofed machine of a spoofed message.

In another embodiment of the invention, a computer readable medium includes executable instructions to receive a message, identify partial authentication content associated with the message, and process the partial authentication content without processing the entirety of the message to develop an authentication response indicative of the authenticity of the message. The computer readable medium includes executable instructions to identify partial authentication content in the form of implicit authentication content associated with the message. Thus, in this embodiment, the insertion of partial authentication content into a message is not required; rather, authentication is established through analysis of the implicit information associated with the message.

### BRIEF DESCRIPTION OF THE FIGURES

The invention is more fully appreciated in connection with the following detailed description taken in conjunction with the accompanying drawings, in which:

FIG. 1 illustrates a network architecture incorporating embodiments of the invention.

FIG. 2 illustrates processing operations associated with a sending machine utilized in accordance with an embodiment of the invention.

FIG. 3 illustrates processing operations associated with a partial authentication module of the invention.

Like reference numerals refer to corresponding parts throughout the several views of the drawings.

### DETAILED DESCRIPTION OF THE INVENTION

The invention relates to using implicit or explicit message content to establish partial authentication of a message. Partial authentication is less than the bit accurate authentication associated with digital signatures. The invention may include sender side authentication operations and/or receiver side authentication operations.

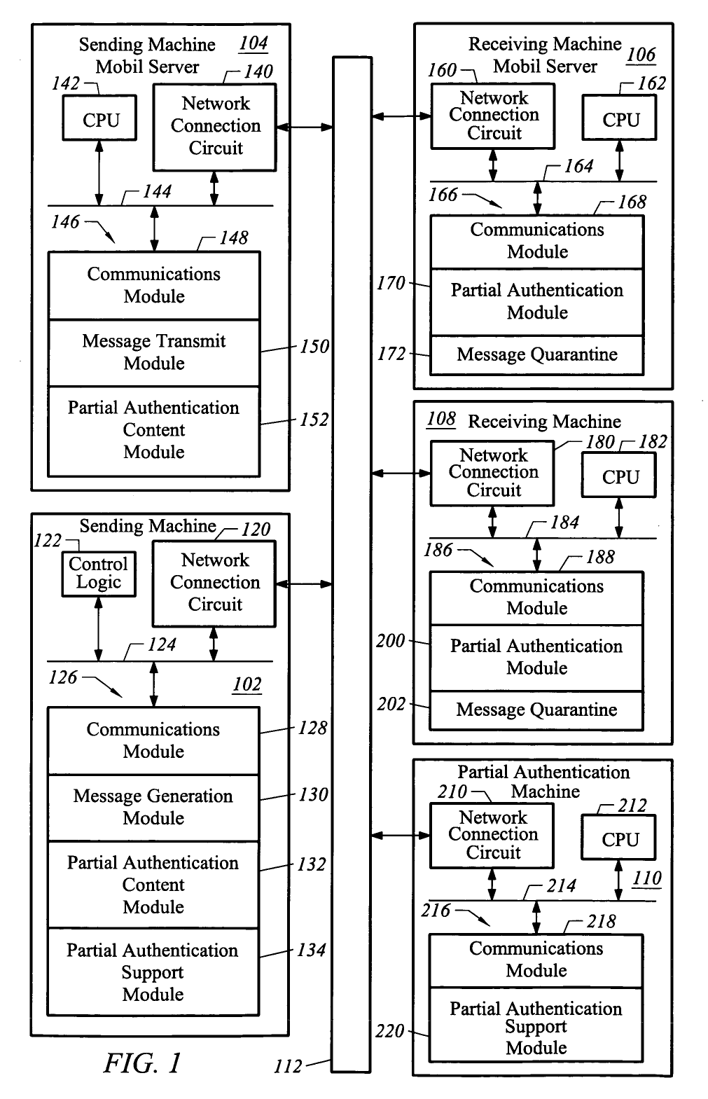

FIG. 1 illustrates an exemplary network 100 configured in accordance with an embodiment of the invention. In this example, the network 100 includes a sending machine 102, a sending machine mail server 104, a receiving machine mail server 106, a receiving machine 108, and a partial authentication machine 110 linked by a transmission medium 112, which may be any wired or wireless transmission medium.

The sending machine 102 may be a computer, personal digital assistant, or the like. The sending machine 102 includes a standard network connection circuit 120 and control logic 122, which may be a CPU, microcontroller, or the like. The network connection circuit 120 and the control logic 122 are connected via a bus 124. Also connected to the bus is a memory 126. The memory 126 stores data and executable code, including a standard communications module 128 and a message generation module 130. The memory 126 also stores a partial authentication content module 132, which includes executable instructions to implement operations associated with the invention. The partial authentication content module 132 selectively inserts content into a message to facilitate authentication operations. For example, the partial authentication content module 132 may include executable code to insert a partial signature into the message. For example, the executable code may designate portions of the message as signed content. Alternately, the partial authentication content module 132 may utilize executable code to insert authentication information into the message. In one embodiment, the authentication information is explicitly marked by a special character (e.g., an asterisk). In another embodiment, the authentication information is implicit to the message and therefore is not explicitly inserted into the message, as will be discussed below.

The partial authentication content module 132 provides a number of advantageous features. For example, if a partial signature is used, then upon receipt of the message, the message can be authenticated by simply processing the partial signature. Thus, the entire message does not have to be processed if there is an authentication problem. With existing digital signatures, the entire message must be processed prior to identifying an authentication problem. Thus, the prior art has computation expenses that are obviated with this embodiment of the invention. The use of a partial signature is also advantageous because as a practical matter, it usually suffices to sign only portions of a message since other portions of a message are less critical. This results in processing efficiencies on both the sending and receiving sides.

The partial authentication content module 132 is also advantageous when it utilizes inserted authentication information. This inserted authentication information imposes a relatively small computational expense, yet affords enhanced security. Similarly, the use of implicit authentication content imposes no computational expense on the sending machine and relatively small computational expense on the receiving machine.

The memory 126 of the sending machine 102 may also include a partial authentication support module 134. As discussed below, this module includes executable instructions to respond to queries from a receiving machine when the receiving machine is taking additional steps to confirm the authenticity of a received message.

FIG. 1 also illustrates a sending machine mail server 104. This machine includes a standard network connection circuit 140, a central processing unit 142, and a bus 144. A memory 146 is connected to the bus 144. The memory 146 stores standard executable programs, including a communications module 148 and a message transmit module 150. Further, the memory 146 stores a partial authentication content module 152. This module is the analog of the client side module 134 of the sending machine 102. That is, the partial authentication content module 152 performs the same or analogous operations as the partial authentication support module 134. Thus, the partial authentication content module may be resident in the sending machine mail server 104 and/or in the sending machine 102. For thin client applications it is desirable to rely upon the sending machine mail server 104. Similarly, this configuration is desirable to obviate software downloads to the sending machine 102.

The exemplary network 100 also includes a receiving machine mail server 106. This machine 106 includes a network connection circuit 160 and a CPU 162 linked by a bus 164. A memory 166 is also connected to the bus. The memory 166 stores a standard communications module 168. In addition, the memory 166 stores a partial authentication module 170, which includes executable instructions to implement authentication operations of the invention. As will be discussed further below, the partial authentication module 170 identifies authentication content in a received message, processes the authentication content and generates an authentication response. One authentication response is to quarantine a message that has not been authenticated. Thus, memory 166 includes message quarantine 172 to store unauthenticated messages.

The receiving machine 108 receives a message from the receiving machine mail server 106. The receiving machine 108 includes a network connection circuit 180, control logic 182, a bus 184, and a memory 186. The memory 186 stores a standard communications module 188. In the event that the receiving machine mail server 106 includes a partial authentication module 170 and message quarantine 172, then the receiving machine 108 may operate as a passive recipient of the message. In an alternate embodiment, the receiving machine 108 stores the partial authentication module 200 and the message quarantine 202. While sub-optimal, this embodiment is disclosed to underscore that the functions of the invention may be performed practically anywhere in the network 100. It is the functions of the invention that are significant, not the particular processing points of the functions.

FIG. 1 also illustrates a partial authentication machine 110. The machine 110 includes standard components, such as a network connection circuit 210, a CPU 212, a bus 214, and a memory 216. The memory 216 includes a standard communications module 218. In addition, the memory 216 stores a partial authentication support module 220. This module 220 includes executable instructions to facilitate the authentication of messages. In one embodiment, the partial authentication support module 220 includes a database storing IP addresses and the owners of those IP addresses. The module further includes executable instructions to process a request that endeavors to determine whether a message from a certain IP address should be trusted in view of domain ownership issues. Thus, the database of IP addresses and owners is used along with a set of rules to provide an authentication determination. As with the other modules of the invention, the partial authentication support module 220 may be executed at practically any location in the network 100 and therefore need not be resident on partial authentication machine 110.

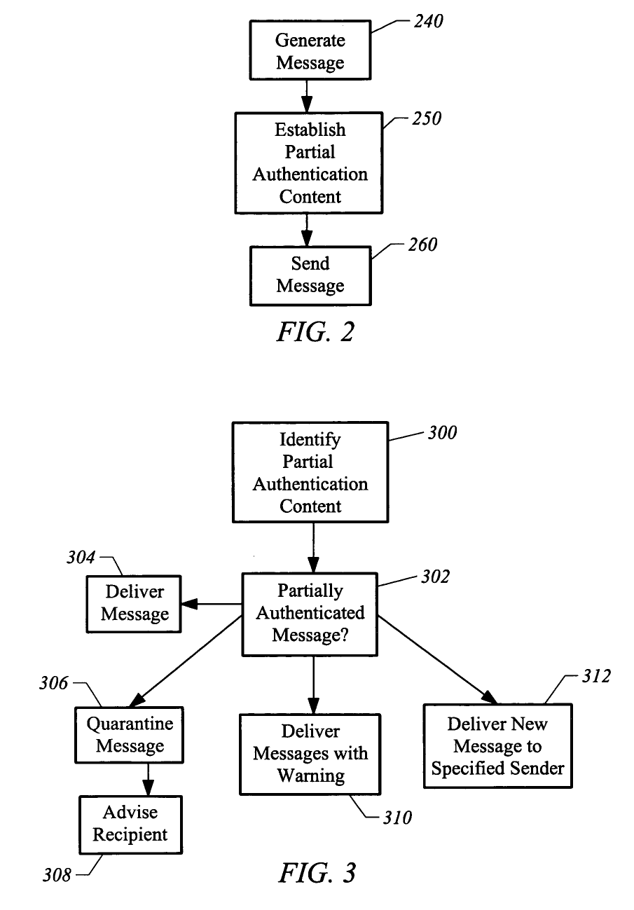

FIG. 2 illustrates processing steps associated with the operation of the sending machine 102. Initially, the sending machine generates a message (240). The message generation module 130 may be used to implement this operation. The message generation module 130 may be a standard program that is used to generate emails, instant messages, or the like. The next operation of FIG. 2 is to establish partial authentication content (250). The partial authentication content module 132 includes executable instructions to designate selected message content as authentication content. The content may be added to the message. For example, a partial signature may be added to the content, a code word may be added to the content, and the like. Alternately, implicit content of the message may be used, as discussed below. In the case of implicit content, the message content module 132 is not used. The message with the authentication content is then sent (260). Standard techniques, such as those supported by the communications module 128, may be used in this operation.

FIG. 3 illustrates processing operations associated with the partial authentication module 170/200, which may be resident on the receiving machine mail server 106 and/or the receiving machine 108. The first operation of the module is to identify partial authentication content (300). In one embodiment, executable instructions are used to identify a partial signature. In another embodiment, executable instructions are used to identify authentication content. In another embodiment, implicit content is processed.

The next operation of FIG. 3 is to process the message to establish partial authentication of the message (302). The partial authentication may be based upon a partial signature, selected explicit authentication content, or selected implicit authentication content. The authentication content of the message is processed to develop an authentication response. Observe that the invention is operative with respect to the authorization content. Thus, the entire message does not have to be processed. This stands in stark contrast to computationally expensive prior art techniques that process an entire message.

If the message is partially authenticated, then it is delivered (304). On the other hand, if the message is not partially authenticated, then a number of processing operations are available. In one embodiment, the message is quarantined (306). For example, the message may be sent to message quarantine 172 and a separate message advising of the quarantined message may be sent to the recipient (308). Another option in the event of a message that is not partially authenticated is to deliver the message with a warning (310). Another option in accordance with an embodiment of the invention is to deliver the message back to the spoofed sender (312). For example, if the message is identified as having a spoofed sending address, then the message is sent to the spoofed sending address so that the spoofed entity can take appropriate remedial measures.

The invention has been fully described. Attention now turns to a more detailed discussion of various authentication criteria and non-authentication responses that may be used in accordance with embodiments of the invention.

One form of authentication that may be used by the partial authentication module 200 is to communicate with another machine about the received message. For example, the partial authentication module 200 of the receiving machine may communicate with the partial authentication support module of sending machine 102. In this example, the partial authentication module 200 includes executable instructions to advise the partial authentication support module 134 that a message was received with certain characteristics and further solicits a response as to whether the sending machine 102 sent such a message. For example, in the case where the correspondence is between a company and its registered users, or customers in a loyalty program, the partial authentication support module 134 tracks what messages it has sent. The partial authentication support module 134 may also operate by tracking when messages were last sent to a user. Thus, if the last message was sent to a particular user on October 2, a message sent on October 19 cannot be real. This sort of spoof-detection aids businesses that are being spoofed through attacks on their users.

The partial authentication module 200 can also be implemented to rely solely upon recipient-side message analysis, logging and auditing. As previously discussed, the message analysis is based upon authentication content. The authentication content may be explicit (e.g., a partial signature or a codeword) or implicit. Implicit content is inherent to the message itself. For example, a timestamp or IP address of the message provides passive authenticity information. Other information that is not specifically put in the message, but is part of the environment of the message may also be used as implicit content. The implicit content may be used to identify an inauthentic message. For example, an inauthentic message may be identified passively through a variety of rule-based operations. For example, known information about a sender, such as the set of IP addresses she uses and the time of day she typically sends messages can be used for partial authentication. Alternately, the inherent content of the message can be used. For example, a message with a “From” address of “ebay.com” that contains a URL to www.identity-thieves-r-us.iq can be identified as an inauthentic message through a set of rules requiring reasonable correspondence between the source of the message and links within the message. Passive or implicit authenticity marks also include the sending timestamp, an SMTP message id, X-headers in a message, and the sender host id in an SMTP HELO command. Some of these, like the message id and sending time have the advantage that they are not typically preserved when a message is forwarded.

Explicit authentication content utilized in accordance with embodiments of the invention includes non-cryptographic marks. Explicit authentication content may be a key, either shared with the recipient or not. Timestamps, random numbers, and counters are all usable non-cryptographic authenticity content or authenticity marks. The subject of a message is itself a non-cryptographic authenticity mark with certain value to it; it forces the attacker to use a constrained set of email subjects.

The invention may also rely upon cryptographic authenticity content or authenticity marks. There are a variety of cryptographic mechanisms that can be used to create authenticity marks. The simplest cryptographic marks are hashes over some canonicalized input. For example, a SHA-1 hash of the message subject and body, with non-ASCII-alphabetic characters removed, and those alphabetic characters case-normalized may be used. Additionally, quoted-printable, HTML ampersand-escapes and percent-escapes may be removed in accordance with this approach.

More complex keyed hashes, salted hashes, and MACs may also be used in accordance with an embodiment of the invention. If the sender and recipient share a secret (like a passphrase), then the key for a hash or MAC can be derived from that shared secret. Alternatively, the key can be held solely by the sender, which is given the message so that it can perform an authenticity check on the message. The sender then needs to keep relevant information, like the cryptographic token and key. The key can be per user, per message, per message-group (this official mailing uses a MAC key of K), per time interval (official messages sent on date D use a key of K_{D}), etc.

The authenticity mark can also be a more complex cryptographic object similar to a PGP license number. For example, it could be a 32-bit user ID, a 64-bit truncated hash of all the URLs in the message, and a 32-bit truncated hash of the two of those—all of that encrypted with AES to a per-user daily key, K_{userday}. That 128-bit number is made printable the same way license numbers are and is used in the SMTP message id for the email. This particular construction has some interesting properties. The construction is unique to each recipient and day. An attacker cannot transfer it to a sent message. The authenticity check is over the URLs in the message, which is where many attacks for user secrets exist. The technique permits the sender to pre-compute authenticity marks from a secure server while generating messages unique to each recipient from some other server. All the generation mechanism has to do is put the right URLs in the right order somewhere in the message and add in the authenticity mark.

Digital signatures may also be used in accordance with an embodiment of the invention. A digital signature may be used in connection with a portion of the message. This partial approach is for the purpose of establishing some form of authentication without incurring significant computational expense or otherwise invoking other shortcomings of the prior art.

There are a variety of other techniques that may be used to provide partial authentication of a message. For example, the partial authentication module 170 may include executable instructions to confirm that URLs in the message point to known web servers. The partial authentication support module 220 may be queried in the process of this operation. The partial authentication module 170 may also include executable instructions to look at SMTP headers for known good and bad things. For example, there must be a “Received:” header coming from the managed domain—if one exists, it could be spoofed, but if there isn't one, the message is presumably spoofed. One can also check for other known things such as X-headers for mailing list subscription management, the proper X-Mailer header, and so on. Again, these techniques do not guarantee authenticity, but they provide partial authenticity suitable for embodiments of the invention.

Partial authentication in accordance with the invention also contemplates a variety of cryptographic techniques. A partial signature, for example over only URLs, may be used. The partial authentication module 200 may also initiate a dialog with the partial authentication support module 132 of the sending machine 102. This can be a single communication or a staged communication. For example, the partial authentication module 200 may send a query to the partial authentication support module 134 asking if a message was sent with a given message-id. If so, a cryptographic mark is computed and a query is sent to determine if it is valid.

As previously discussed and as shown in FIG. 3, if a message is not authenticated, there are a number of processing options. The message may be placed in message quarantine 172. The message quarantine 172 may be a special folder. The message may also be deleted.

The message may also be delivered with a warning. For example, the message may be delivered with a header indicating that the message is probably spam. Parts of the message may also be re-written to delete or neutralize hazardous content, like URLs to bogus sites. Finally, as previously discussed, a spoofed message can be sent to a legitimate sender to allow the legitimate sender to refine anti-spoofing mechanisms.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium, comprising executable instructions to:
insert partial authentication content into a message; and
process said partial authentication content without processing the entirety of said message to develop an authentication response indicative of the authenticity of said message.

2. The computer readable medium of claim 1 wherein said executable instructions include executable instructions to insert partial authentication content in the form of a partial signature associated with a segment of said message.

3. The computer readable medium of claim 1 wherein said executable instructions include executable instructions to insert explicit partial authentication content to form a segment of said message.

4. The computer readable medium of claim 1 wherein said executable instructions include executable instructions to process said partial authentication content to develop an authentication response of a partially authenticated message suitable for delivery to a recipient.

5. The computer readable medium of claim 1 wherein said executable instructions include executable instructions to process said partial authentication content to develop an authentication response of quarantining said message.

6. The computer readable medium of claim 5 wherein said executable instructions include executable instructions to process said partial authentication content to develop an authentication response of sending a recipient a message advising that a received message is quarantined.

7. The computer readable medium of claim 1 wherein said executable instructions include executable instructions to process said partial authentication content to develop an authentication response of a delivered message corresponding to said message and further including a warning to said recipient.

8. The computer readable medium of claim 1 wherein said executable instructions include executable instructions to process said partial authentication content to develop an authentication response including modified content of said message.

9. The computer readable medium of claim 1 wherein said executable instructions include executable instructions to process said partial authentication content to develop an authentication response in the form of a message to a spoofed message source advising of a spoofed message.

10. The computer readable medium of claim 1 wherein said executable instructions include executable instructions to contact a machine to confirm authenticity of said message.

11. The computer readable medium of claim 10 wherein said executable instructions include executable instructions to contact a machine that purportedly sent said message.

12. The computer readable medium of claim 10 wherein said executable instructions include executable instructions to contact a machine that stores domain ownership attributes.

13. A computer readable medium, comprising executable instructions to:
receive a message;
identify partial authentication content associated with said message; and
process said partial authentication content without processing the entirety of said message to develop an authentication response indicative of the authenticity of said message.

14. The computer readable medium of claim 13 wherein said executable instructions include executable instructions to identify partial authentication content in the form of a partial signature associated with a segment of said message.

15. The computer readable medium of claim 13 wherein said executable instructions include executable instructions to identify partial authentication content in the form of implicit authentication content associated with said message.

16. The computer readable medium of claim 13 wherein said executable instructions include executable instructions to process said partial authentication content to develop an authentication response including modified content of said message.

17. The computer readable medium of claim 13 wherein said executable instructions include executable instructions to process said partial authentication content to develop an authentication response of a message to a spoofed message source advising of a spoofed message.

18. The computer readable medium of claim 13 wherein said executable instructions include executable instructions to contact a machine to confirm authenticity of said message.

19. The computer readable medium of claim 18 wherein said executable instructions include executable instructions to contact a machine that purportedly sent said message.

20. The computer readable medium of claim 18 wherein said executable instructions include executable instructions to contact a machine that stores domain ownership attributes.
